(19) United States
(12) Patent Application Publication
(10) Pub. No.: US 2009/0259759 A1
(43) Pub. Date: Oct. 15, 2009

(54) TERMINAL DEVICE, NETWORK CONNECTION METHOD, AND COMPUTER READABLE MEDIUM HAVING PROGRAM STORED THEREIN

(76) Inventor: Hiroaki MIYAJIMA, Tokyo (JP)

Correspondence Address: NEC CORPORATION OF AMERICA, 6535 N. STATE HWY 161, IRVING, TX, 75039, US

(21) Appl. No.: 12/406,536

(22) Filed: Mar. 18, 2009

(30) Foreign Application Priority Data
Apr. 9, 2008 (JP) 2008-101408

(51) Int. Cl. G06F 15/16; G06F 9/455

(52) U.S. Cl. 709/229; 718/1

(57) ABSTRACT

A virtual machine system including a user virtual machine for operating a user environment, and a service virtual machine for controlling the user virtual machine, and performing network connection is constructed on a terminal device capable of being connected to a network, and the service virtual machine controls the network use by the user virtual machine depending on the security of the network to which the terminal device is directly connected.

### INCORPORATION BY REFERENCE

This application is based upon and claims the benefit of priority from Japanese patent application No. 2008-101408, filed on Apr. 9, 2008, the disclosure of which is incorporated herein in its entirety by reference.

### TECHNICAL FIELD

The present invention relates to a terminal device that can be connected to a network, and its network connection method and program.

### BACKGROUND ART

Recently, home/public network connection environment is being increasingly improved, and opportunities to establish network connection outside a company are being increased when a portable information terminal such as a laptop personal computer having important information stored therein is brought out from a company (outside).

One problem with establishment of network connection outside the company is that important information may leak out of the company through the connected network.

As a measure against it, there is a setting method for limiting to a virtual private network (VPN) endpoint (server) a destination to which the portable information terminal is connected, so that only the communication with the VPN endpoint can be established. According to this method, only the VPN is used when network connection is established outside the company, therefore, the security of network use outside the company is considered to be ensured. The related art in which such a VPN is used to establish connection has been described in Patent Document 1.

Patent Document 1: Japanese Patent Application Laid-Open Patent Publication No. 2004-280595

In the method of using the VPN as described above, under the circumstances where service from an outside server is used outside the company, for example, when general information is obtained from an outside web server, the information is obtained through the VPN, thus, there is a problem that access efficiency is reduced.

There is another problem that the service from the outside server may not be used outside the company if some access control is imposed on the VPN endpoint and an intra-company network, or if some trouble occurs on the VPN endpoint. There is still another problem that an excessive load is placed on the VPN endpoint.

In order to address these problems, there is a need to achieve a method for ensuring the security of network use, as well as providing its convenience.

### EXEMPLARY OBJECT OF THE INVENTION

The present invention is made to solve the problems described above, and an exemplary object of the present invention is to provide a terminal device, a network connection method and a program capable of ensuring the security of network use through the terminal device as well as providing its convenience.

### SUMMARY

A first exemplary aspect of the invention, a terminal device capable of being connected to a network, wherein

a virtual machine system including a user virtual machine for operating a user environment, and a service virtual machine for controlling the user virtual machine, and performing network connection processing is constructed on the terminal device,

the service virtual machine

controls utilization of the network by the user virtual machine, depending on security of the network to which the terminal device is directly connected.

A second exemplary aspect of the invention, a network connection method of a terminal device capable of being connected to a network, wherein

a virtual machine system is constructed on the terminal device, which virtual machine includes a user virtual machine for operating a user environment; and a service virtual machine for controlling the user virtual machine, and performing network connection, wherein

in the service virtual machine,

controlling utilization of the network by the user virtual machine, depending on security of the network to which the terminal device is directly connected.

A third exemplary aspect of the invention, a computer readable medium storing a program operating on a terminal device capable of being connected to a network, and connecting the terminal device to the network,

the program causes

a virtual machine system, which is constructed on the terminal device, and includes a user virtual machine for operating a user environment, and a service virtual machine for controlling the user virtual machine, and performing network connection,

to control utilization of the network by the user virtual machine, depending on security of the network to which the terminal device is directly connected.

According to the present invention, both the security of network use through a terminal device and its convenience can be realized.

### BRIEF DESCRIPTION OF THE DRAWINGS

FIG. 1 is a block diagram illustrating the configuration of a virtual machine system according to an exemplary embodiment of the present invention;

FIG. 2 is a flow chart illustrating line connection control processing of the virtual machine system according to the exemplary embodiment of the present invention;

FIG. 3 is a diagram illustrating an example of a network connection menu through a UI function of the virtual machine system according to the exemplary embodiment of the present invention;

FIG. 4 is a diagram illustrating an example of the configuration of a line connection control table of the virtual machine system according to the exemplary embodiment of the present invention;

FIG. 5 is a diagram illustrating an example of the configuration of an internal determination control table of the virtual machine system according to the exemplary embodiment of the present invention;

FIG. 6 is a diagram illustrating an example of the system configuration for an internal network authentication command in the virtual machine system according to the exemplary embodiment of the present invention;

FIG. 7 is a diagram illustrating communication through an internal network in the virtual machine system according to the exemplary embodiment of the present invention;

FIG. 8 is a diagram illustrating communication through an external network in the virtual machine system according to the exemplary embodiment of the present invention;

FIG. 9 is a flow chart illustrating communication node control request processing and virtual machine activation request processing in the virtual machine system according to the exemplary embodiment of the present invention;

FIG. 10 is a flow chart illustrating virtual machine stop request processing in the virtual machine system according to the exemplary embodiment of the present invention;

FIG. 11 is a diagram illustrating an example of device use control in the internal network according to another exemplary embodiment of the present invention; and

FIG. 12 is a diagram illustrating an example of device use control in the external network according to another exemplary embodiment of the present invention.

### EXEMPLARY EMBODIMENT

Exemplary embodiments of the present invention will now be described in detail with reference to the drawings.

### First Exemplary Embodiment

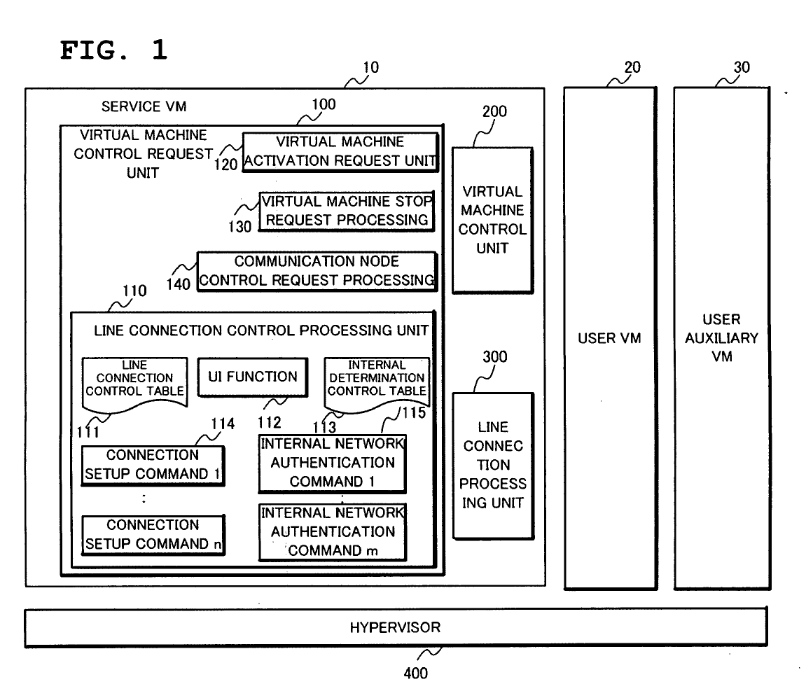

FIG. 1 is a block diagram illustrating the configuration of a virtual machine system according to a first exemplary embodiment for implementing the present invention.

In the present exemplary embodiment, a virtual machine system constructed on a terminal device such as a laptop personal computer is used to ensure the security of network use and provide its convenience adaptively to the environment of a connected network. The virtual machine system, which is a scheme for virtually realizing a system platform on which user environment operates, includes a virtual machine (VM), which is a virtually realized system platform, and a hypervisor (also referred to as VMM) for managing the virtual machine and managing system resources such as a CPU and a memory.

A plurality of virtual machines may exist on a hypervisor 400. In the virtual machine system, a special virtual machine referred to as a service VM is used to handle an interface for controlling physical devices and managing the virtual machine system.

Note that the service VM may be integrated into the hypervisor, or may be separated into a plurality of components for each function. In the present exemplary embodiment, a case where one service VM exists will be described, which can also be applied to other cases.

Referring to FIG. 1, the virtual machine system constructed on a terminal device such as a laptop personal computer according to the present exemplary embodiment includes a service VM 10, a user VM 20, a user auxiliary VM 30 and a hypervisor 400.

The user VM 20 is a virtual machine used in the environment (user environment) where operating systems and applications access important data. The user auxiliary VM 30 is a virtual machine used in the environment (user auxiliary environment) where operating systems and applications do not handle important data.

The service VM 10 includes a virtual machine control request unit 100 for making a request for a line connection control and accompanying virtual machine control, a virtual machine control unit 200 for controlling the virtual machine, and a line connection processing unit 300 for performing processing related to network connection.

Among these components in the service VM 10, the virtual machine control request unit 100 is a component specific to the present exemplary embodiment, and the others are components usually provided on a network processing function and a virtual machine system function.

The virtual machine control request unit 100 in the service machine VM 10 controls the virtual machine system through a management interface of the virtual machine system which the service VM 10 has, and includes a line connection control processing unit 110 for controlling network connection, a virtual machine activation request processing 120 for requesting the virtual machine control unit 200 to activate the virtual machine, a virtual machine stop request processing 130 for requesting the virtual machine control unit 200 to stop the virtual machine, and a communication node control request processing 140 for requesting the virtual machine control unit 200 to control the communication node.

The line connection control processing unit 110 includes a line connection control table 111 for defining a network connection method used for control and authentication of a network line connection, a user interface (UI) function 112, which is a user interface function for selectably displaying a list of network connection methods on a display screen, an internal determination control table 113 used to control determination as to whether the network line is internally connected, a connection setup command (or command group) 114 used for network line connection and setup, and an internal network authentication command (or command group) 115 used for authentication of the network being internally connected.

The detailed functions and operation of each component of the virtual machine control request unit 100 and the line connection control processing unit 110 will be described below.

### operation of the First Exemplary Embodiment

Operation according to the first exemplary embodiment constituted as described above will be described with reference to FIG. 1 and FIGS. 2 to 10.

As described above, in the present exemplary embodiment, a virtual machine system is used. A network to which a terminal device serving as a real machine is directly connected in a safe environment such as an intra-company network is referred to as an internal network, and a network other than an internal network is referred to as an external network herein.

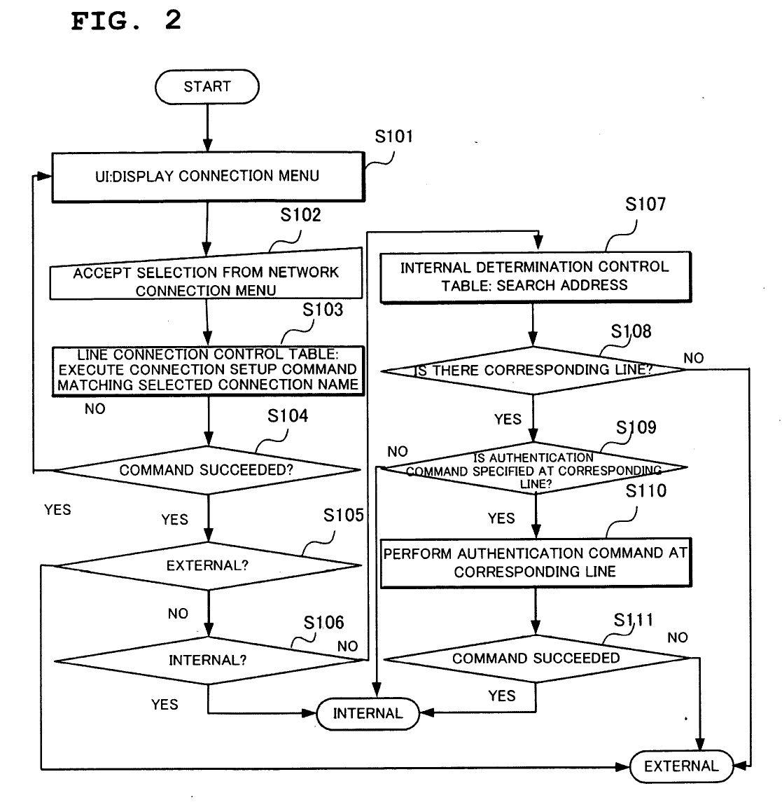

FIG. 2 is a flow chart illustrating the operation of the line connection control processing unit 110, which uses the line connection processing unit 300 to establish network connection, and determines whether the connected network is an internal network or an external network.

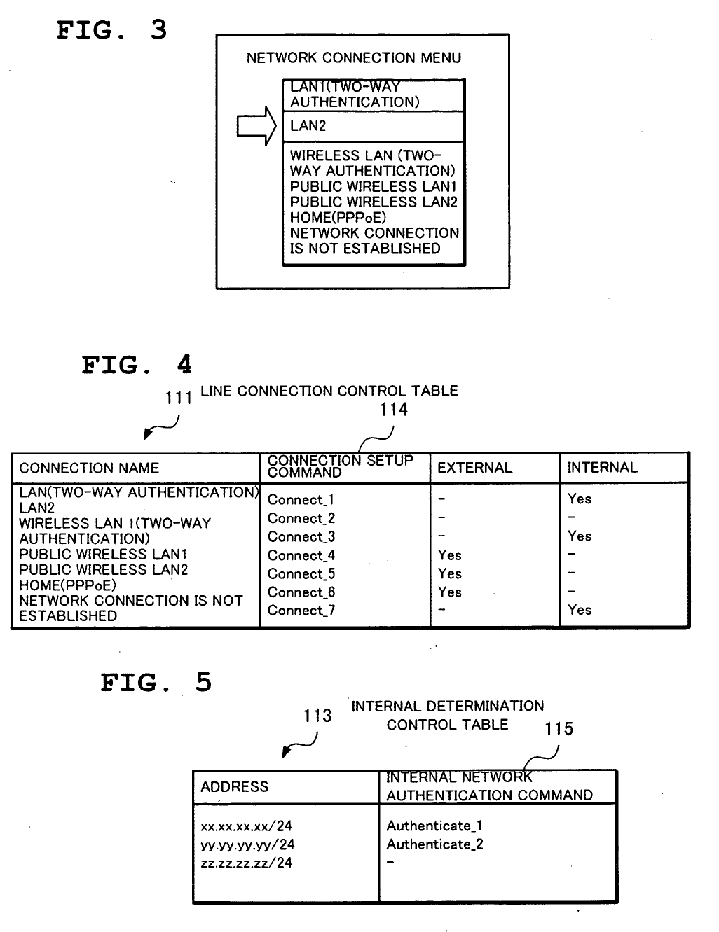

In Step S101, a list of network connection methods is displayed through the UI function 112. In so doing, a network connection menu as shown in FIG. 3, for example, is displayed. Each item in the network connection menu shown in FIG. 3 corresponds to a connection name field in the line connection control table 111. The line connection control table 111 will be described later.

Note that the type of display of a network connection menu is not limited to the example of FIG. 3, and any type of display may be used as long as a user can select a network connection method.

In Step S102, when the user selects an appropriate network connection method from the displayed network connection menu, the selected network connection method (connection name) is accepted.

In Step S103, a connection setup command from the line in the line connection control table 111, in which the connection name field matches the network connection method (connection name) selected by the user in Step S102, is executed.

The line connection control table 111 is a table as shown in FIG. 4, and has a connection name field for indicating a name identifying a network connection method, a connection setup command field for specifying the connection setup command 114, an external field for indicating whether or not the network is externally connected, and an internal field for indicating whether or not the network is internally connected.

Each connection setup command 114 controls the functions of the line connection processing unit 300 to set up a data link for a real network, and obtain IP address information.

“Yes” in the external field of the line connection control table 111 indicates that it has been known that the corresponding network is explicitly external network. Meanwhile, “Yes” in the internal field indicates that no network connection is established, or that a connected network may be determined to be an internal network by performing server authentication on the network through a server certificate of an X.509 electronic certificate such as IEEE 802.1X/EAP-PEAP.

In the example of the line connection control table 111 in FIG. 4, “Yes” is entered in the internal fields of the connection names of LAN 1 (two-way authentication) and wireless LAN 1 (two-way authentication), because two-way authentication means that the network (server) authenticates the user, and the user authenticates the network (server) mutually. Note that there are no cases where both the external field and the internal field for one connection name in the line connection control table 111 in FIG. 4 indicate “Yes”, on the other hand, there are cases where neither external field nor internal-field indicates “Yes”, as in the connection name LAN 2. The contents of the line connection control table 111 are defined by an administrator, depending on the types of connected networks.

Step S104 is a conditional branch to determine whether or not the connection setup command performed in Step S103 succeeded. If the condition is determined to be NO (failed), the process returns to Step S101.

Step S105 is a conditional branch to determine whether or not the external field in the line connection control table 111 is specified as “Yes”; if the condition determined to be YES, the determination result represents “external” (external network).

Step S106 is a conditional branch to determine whether or not the internal field in the line connection control table 111 is specified as “Yes”; if the condition is determined to be YES, the determination result represents “internal” (internal network).

When the determination result of Step S105 does not represent “external”, and the determination result of Step S106 does not represent “internal”, the processing of Step S107 is performed.

In Step S107, the internal determination control table 113 is searched for an IP address obtained in the connected network.

The internal determination control table 113, which is a table shown in FIG. 5, includes an address field for specifying the range of an IP address, and an internal network authentication command field for specifying the internal network authentication command 115.

The internal network authentication command 115 is a command for checking whether the connected network is an internal network. The internal network authentication command 115 has the address of a server having the server certificate of the X.509 electronic certificate, which should be in the connected network, and the port and connection method of the service, and a route certificate of the X.509 electronic certificate, which the service VM 10 has, is used to verify the server certificate obtained by actually connecting to the service, thus the network is authenticated as an internal network.

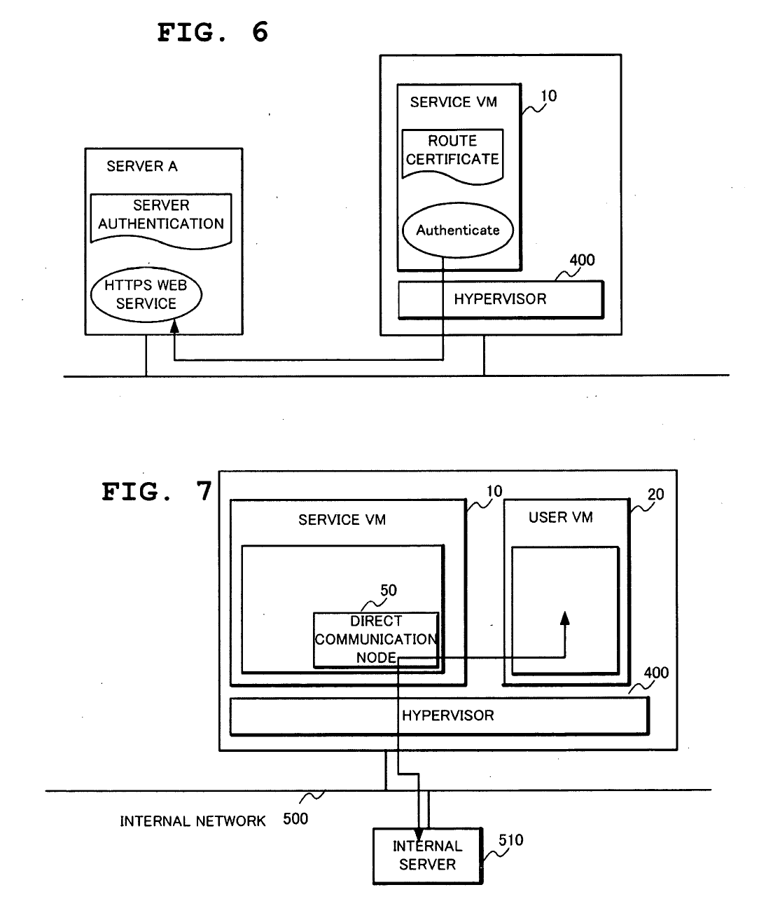

FIG. 6 illustrates an example of the operating environment of the internal network authentication command 115, wherein a server A has an HTTPS web service, “Authenticate”, which is the internal network authentication command 115, is connected to the HTTPS web service through an SSL, and the server certificate submitted by the HTTPS web service is verified by a PKI mechanism using the route certificate, which the service VM 10 has. Then, the internal network authentication command 115 “Authenticate” exits after verifying the server certificate.

In this case, if the verification of the server certificate succeeded, the result represents success, on the other hand, if connection to the server A could not be established, or if the verification of the server certificate failed, the result represents failure. Note that the service, which the server A has, is not limited to the HTTPS web service, and other service may be used, but in order to perform authentication through the server certificate, a server like the server A is needed in the network; if there is no appropriate server, an administrator or the like should prepare for a dummy server having a server certificate. In addition to a normal route certificate, an additional route certificate may be needed to be installed in the server VM 10 by the administrator or the like.

When the internal network authentication command 115 has not been specified in the internal network authentication command field of the internal determination control table 113, this indicates that strict authentication as to whether the connected network is an internal network is not performed, and only address matching is needed. The contents of the internal determination control table 113 are defined by an administrator, depending on the situations of the connected networks.

Step S108 is a conditional branch based on the result of the address search in Step S107, and if there is no matching line in the internal determination control table 113, the determination result represents “external” (external network).

Step S109 is a conditional branch to determine whether or not the internal network authentication command 115 has been specified in the internal network authentication command field when a matching line was found in Step S107, and if the internal network authentication command 115 has not been specified, the determination result represents “internal” (internal network).

In Step S110, the internal network authentication command 115, which has been specified in the internal network authentication command field, is executed.

Step S111 is a conditional branch to determine the result of the internal network authentication command 115 executed in Step S110, and if the command succeeded (YES), the determination result represents “internal” (internal network), on the other hand, if the command failed (NO), the determination result represents “external” (external network).

Next, the operation of the line connection control processing unit 110 when the determination result of the connected network is obtained will be described with reference to FIGS. 7 and 8, and FIG. 9, which shows the contents of the processing.

FIG. 7 shows a case where the connected network is an internal network. A direct communication node is a communication node set on the connected network. In this case, the user VM 20 is activated so that the user VM 20 can directly use the internal network 500 (internal server 510 or the like) through the direct communication node 50 of the service VM 10. Note that the direct communication node 50 corresponds to a virtual network switch for the virtual machine system or equivalents.

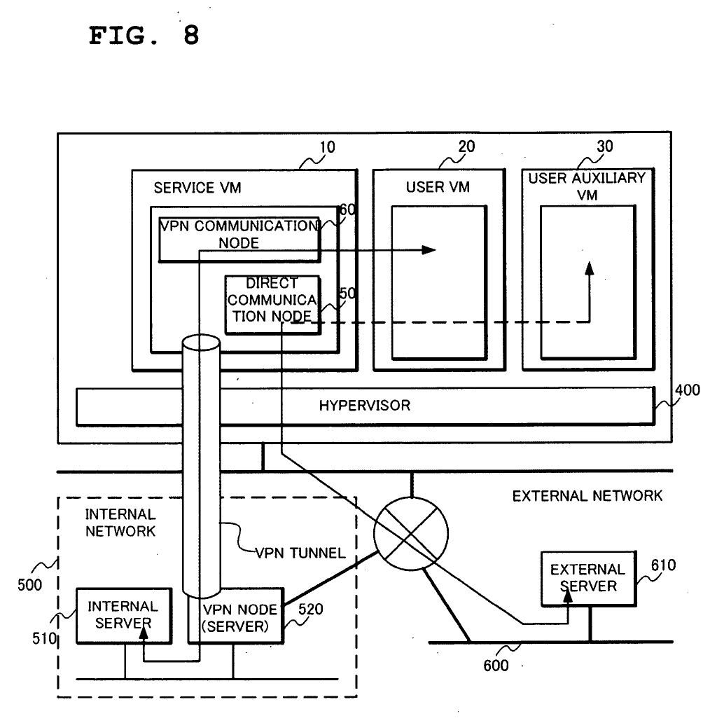

FIG. 8 shows a case where the connected network is an external network. In this case, the service VM 10 establishes a virtual private network (VPN) with the internal network 500, and provides a communication node corresponding to the VPN connection (VPN communication node 60), in addition to the direct communication node 50. The direct communication node 50 and the VPN communication node 60 are on different virtual networks, and cannot communicate with each other. Then, the user VM 20 and the user auxiliary VM 30 are activated. At that time, the user auxiliary VM 30 can directly use the external network 600 (external server 610 or the like) through the direct communication node 50 of the service VM 10, and the user VM 20 can use the internal network 500 (internal server 510 or the like) through the VPN communication node 60 of the service VM 10.

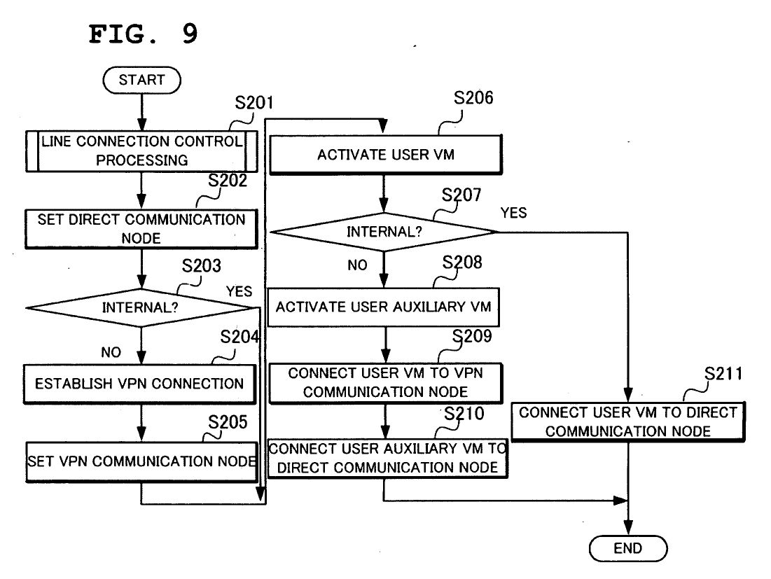

FIG. 9 is a flow chart illustrating the operation of the virtual machine activation request processing 120 and the communication node control request processing 140, which determine the connected network, and configure the environment shown in FIG. 7 or 8.

Note that actual network connection, IP address acquisition, various authentications, and VPN connection are performed using the operating systems and applications in the service VM environment. It is assumed that basic settings on such portions have been performed appropriately by a system administrator or the like.

Step S201 illustrates the processing of the line connection control processing unit 110 described in connection with FIG. 2.

In Step S202, the communication node control request processing 140 requests the virtual machine control unit 200 to create a communication node (direct communication node 50) for a virtual network corresponding to the connected network in the service VM 10.

Step S203 is a conditional branch to determine whether the connected network is an internal network or an external network, with regard to the result of Step S201.

Step S204 is processing performed in a case where the determination result of Step S203 is an external network, in which the communication node control request processing 140 establishes VPN connection by the line connection processing unit 300.

Since settings required for the VPN connection are not directly related to the present exemplary embodiment, it is assumed that the settings have been performed appropriately by a system administrator or the like. Although there are various types of VPNs, such as IPSec, PPTP and Ethernet VPN, the present exemplary embodiment is not limited to a specific VPN scheme, and can be applied to any kind of VPN scheme similarly.

In Step S205, the communication node control request processing 140 requests the virtual machine control unit 200 to create a communication node (VPN communication node 60) for a virtual network corresponding to the VPN connection established in Step S204.

In Step S206, the virtual machine activation request processing 120 requests the virtual machine control unit 200 to activate the user VM 20.

In Step S207, as in Step S203, whether the connected network is an internal network or an external network is determined.

Step S208 is processing performed in a case where the determination result of Step S207 is an external network, in which the virtual machine activation request processing 120 requests the virtual machine control unit 200 to activate the user auxiliary VM 30.

In Step S209, the communication node control request processing 140 requests the virtual machine control unit 200 to connect the user VM 200 to the VPN communication node 60.

In Step S210, the communication node control request processing 140 requests the virtual machine control unit 200 to connect the user auxiliary VM 30 to the direct communication node 50.

Step S211 is processing performed in a case where the determination result of Step S207 is an internal network, in which the communication node control request processing 140 requests the virtual machine control unit 200 to connect the user VM 20 to the direct communication node 50.

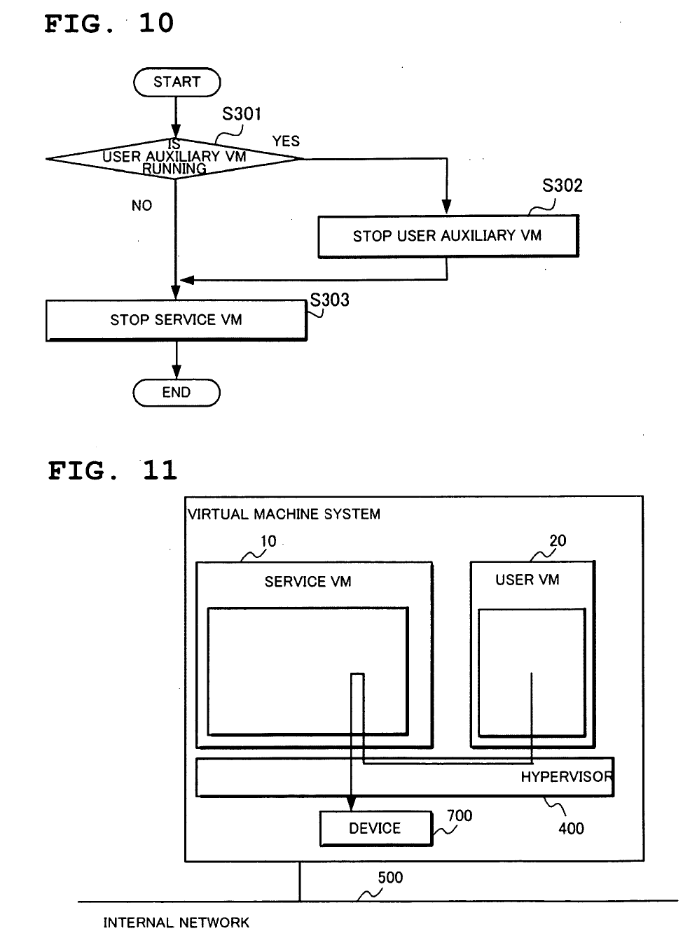

FIG. 10 is a flow chart illustrating the operation of the virtual machine stop request processing 130 when the user VM 20 is stopped.

When the user VM 20 is shut down, the user VM 20 is stopped; at this moment, the virtual machine control request unit 100 of the service VM 10 is notified by the virtual machine control unit 200 that the user VM is stopped, and then processing shown in FIG. 10 is started.

Step S301 is a conditional branch to determine whether or not the user auxiliary VM 30 is running.

In Step S302, if the determination result of Step S301 is YES (running), the virtual machine control unit 200 is requested to stop the user auxiliary VM 30.

In Step S303, the virtual machine control unit 200 is requested to stop the service VM 10. Upon stopping the service VM 10, the hypervisor 400 is also stopped, thus the entire virtual machine system is stopped.

### Effects of the First Exemplary Embodiment

According to the first exemplary embodiment described above, both security and convenience of network use can be realized adaptively to the environment of a connected network. The reason is that the following processing can be achieved without a user performing bothersome management operation of the virtual machine system.

Regarding the user VM having important data, when a network is an internal network assumed to be secure, the user VM may use the network as-is, on the other hand, when the network is an external network, the user VM cannot use the network.

Further, when the network is an external network, a VPN connection is established so that the user VM may use only the VPN.

Moreover, when the network is an external network, the user auxiliary VM without important data is activated so that the network can be used as-is in the user auxiliary VM environment.

Whether the network is an internal network or an external network is properly judged so that such a network and virtual machines (user VM and user auxiliary VM) may be controlled automatically.

### Other Exemplary Embodiments

Next, other exemplary embodiments according to the present invention will be described.

In the first exemplary embodiment described above, a case has been described where whether the connected network is an internal network or an external network is determined to change the ways of activating the user VM 20 and the user auxiliary VM 30, and the connection method to the network, which can be applied to various devices (e.g., USB memory).

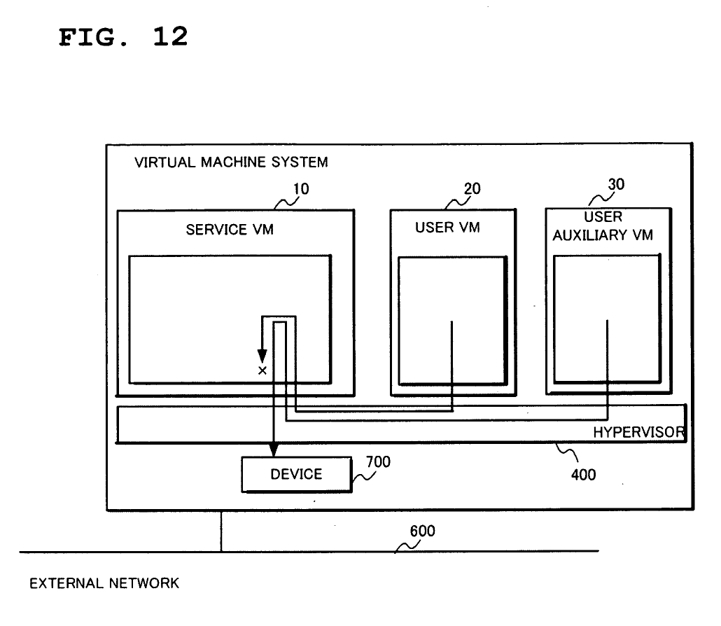

FIG. 11 illustrates a state where, when the connected network is an internal network, a device 700 including a USB memory can be used by the user VM 20. On the other hand, FIG. 12 illustrates a state where, when the connected network is an external network, the device 700 cannot be used by the user VM 20, but can be used by the user auxiliary VM 30.

Although the preferred exemplary embodiments and examples of the present invention have been described, the present invention is not necessarily limited thereto, and various modifications may be made without departing from the technical idea.

### INDUSTRIAL APPLICABILITY

The present invention can be applied to general portable information terminals such as a laptop personal computer, a mobile phone and a PDA, as a mobile terminal device.

What is claimed is:

1. A terminal device capable of being connected to a network, wherein
a virtual machine system including a user virtual machine for operating a user environment, and a service virtual machine for controlling said user virtual machine, and performing network connection processing is constructed on said terminal device,
said service virtual machine
controls utilization of said network by said user virtual machine, depending on security of said network to which said terminal device is directly connected.

2. The terminal device according to claim 1, wherein
said user virtual machine is a virtual machine for operating a user environment including an operating system and an application to access important data, and
said service virtual machine
sets said user virtual machine to be able to directly using said network when said network to which said terminal device is connected is a secure internal network, and
establishes a VPN connection so that said user virtual machine can use said network through the VPN when said network is an insecure external network.

3. The terminal device according to claim 2, including
as said user virtual machine, an auxiliary virtual machine for operating a user environment separated from important data, wherein
said service virtual machine
activates said auxiliary virtual machine so as to be able to directly using said network when said network is an insecure external network.

4. The terminal device according to claim 2, wherein
said service virtual machine
comprises a line connection control processing unit for determining whether said network to which said mobile terminal is directly connected is said internal network, or said external network.

5. The terminal device according to claim 4, wherein
said line connection control processing unit
comprises a line connection control table in which information is set in advance indicating whether said network to which said mobile terminal is directly connected is said internal network or said external network, and
refers to said line connection control table to determine whether said network is said internal network or said external network.

6. The terminal device according to claim 5, wherein
said line connection control processing unit
comprises an internal determination control table in which an IP address range of a network is associated with a command for checking whether a connected network is an internal network,
searches in said internal determination control table for an IP address obtained in said network when whether said network is said internal network or said external network cannot be determined from said line connection control table,
executes said corresponding command when said obtained IP address exists in said internal determination control table, and if said command succeeded, determines that said network is said internal network, and
determines said network is said external network when said obtained IP address does not exist in said internal determination control table or when said command failed.

7. The terminal device according to claim 1, wherein
said service virtual machine
creates a communication node for communicating with a virtual network corresponding to said network, and a VPN communication node for communicating with a virtual network corresponding to a VPN connection established with said network, in said service virtual machine,
activates said user virtual machine to connect to said communication node when said network is said internal network, and
activates said user virtual machine to connect to said VPN communication node when said network is said external network.

8. The terminal device according to claim 7, wherein
said service virtual machine
activates said auxiliary virtual machine to connect to said communication node when said network is said external network.

9. The terminal device according to claim 3, wherein
when said user virtual machine is stopped, whether said auxiliary virtual machine is running is determined, and when said auxiliary virtual machine is running, said auxiliary virtual machine is stopped, then said service virtual machine is stopped.

10. A network connection method of a terminal device capable of being connected to a network, wherein
a virtual machine system is constructed on said terminal device, which virtual machine includes a user virtual machine for operating a user environment, and a service virtual machine for controlling said user virtual machine, and performing network connection, wherein
in said service virtual machine,
controlling utilization of said network by said user virtual machine, depending on security of said network to which said terminal device is directly connected.

11. The network connection method according to claim 10, wherein
said user virtual machine is a virtual machine for operating an user environment including an operating system and an application to access important data, and
said service virtual machine
sets said user virtual machine to be able to directly using said network when said network to which said terminal device is connected is a secure internal network, and
establishes a VPN connection so that said user virtual machine can use said network through the VPN when said network is an insecure external network.

12. The network connection method according to claim 11, wherein
as said user virtual machine, an auxiliary virtual machine for operating a user environment separated from important data, wherein
said service virtual machine
activates said auxiliary virtual machine so as to be able to directly using said network when said network is an insecure external network.

13. The network connection method according to claim 11, comprising
a determination step of said service virtual machine determining whether said network to which said mobile terminal is directly connected is said internal network or said external network.

14. The network connection method according to claim 13, wherein
in said determination step,
a line connection control table in which information is set in advance indicating whether said network to which said mobile terminal is directly connected is said internal network or said external network is referred to determine whether said network is said internal network or said external network.

15. The network connection method according to claim 14, wherein
in said determination step,
an internal determination control table is searched in which an IP address range of a network is associated with a command for checking whether a connected network is an internal network, for an IP address obtained in said network when whether said network is said internal network or said external network cannot be determined from said line connection control table,
said corresponding command is executed when said obtained IP address exists in said internal determination control table, and if said command succeeded, said network is determined to be said internal network, and
said network is determined to be said external network when said obtained IP address does not exist in said internal determination control table or when said command failed.

16. The network connection method according to claim 10, wherein
said service virtual machine
creates a communication node for communicating with a virtual network corresponding to said network, and a VPN communication node for communicating with a virtual network corresponding to a VPN connection established with said network, in said service virtual machine,
activates said user virtual machine to connect to said communication node when said network is said internal network, and
activates said user virtual machine to connect to said VPN communication node when said network is said external network.

17. The network connection method according to claim 16, wherein
said service virtual machine
activates said auxiliary virtual machine to connect to said communication node when said network is said external network.

18. The network connection method according to claim 12, wherein
when said user virtual machine is stopped, whether said auxiliary virtual machine is running is determined, and when said auxiliary virtual machine is running, said auxiliary virtual machine is stopped, then said service virtual machine is stopped.

19. A computer readable medium storing a program operating on a terminal device capable of being connected to a network, and connecting said terminal device to said network,
said program causes
a virtual machine system, which is constructed on said terminal device, and includes a user virtual machine for operating a user environment, and a service virtual machine for controlling said user virtual machine, and performing network connection,
to control utilization of said network by said user virtual machine, depending on security of said network to which said terminal device is directly connected.

20. The computer readable medium according to claim 19, wherein
said user virtual machine is a virtual machine for operating an user environment including an operating system and an application to access important data, and
said program causes
said service virtual machine to
set said user virtual machine to be able to directly using said network when said network to which said terminal device is connected is a secure internal network, and
establish a VPN connection so that said user virtual machine can use said network through the VPN when said network is an insecure external network.

21. The computer readable medium according to claim 20, wherein
as said user virtual machine, an auxiliary virtual machine for operating a user environment separated from important data is included, wherein
said program causing said service virtual machine
to activate said auxiliary virtual machine so as to be able to directly using said network when said network is an insecure external network.

22. The computer readable medium according to claim 20, wherein said program causing said service virtual machine to perform determination processing for determining whether said network to which said mobile terminal is directly connected is said internal network or said external network.

23. The computer readable medium according to claim 22, wherein
in said determination processing,
a line connection control table in which information is set in advance indicating whether said network to which said mobile terminal is directly connected is said internal network or said external network is referred to determine whether said network is said internal network or said external network.

24. The computer readable medium according to claim 23, wherein
in said determination processing,
an internal determination control table is searched in which an IP address range of a network is associated with a command for checking whether a connected network is an internal network, for an IP address obtained in said network when whether said network is said internal network or said external network cannot be determined from said line connection control table,
said corresponding command is executed when said obtained IP address exists in said internal determination control table, and if said command succeeded, said network is determined to be said internal network, and
said network is determined to be said external network when said obtained IP address does not exist in said internal determination control table or when said command failed.

25. The computer readable medium according to claim 19, wherein said program causing said service virtual machine to
create a communication node for communicating with a virtual network corresponding to said network, and a VPN communication node for communicating with a virtual network corresponding to a VPN connection established with said network, in said service virtual machine,
activate said user virtual machine to connect to said communication node when said network is said internal network, and
activate said user virtual machine to connect to said VPN communication node when said network is said external network.

26. The computer readable medium according to claim 25, wherein said program causing said service virtual machine
to activate said auxiliary virtual machine to connect to said communication node when said network is said external network.

27. The computer readable medium according to claim 21, wherein
when said user virtual machine is stopped, whether said auxiliary virtual machine is running is determined, and when said auxiliary virtual machine is running, said auxiliary virtual machine is stopped, then said service virtual machine is stopped.
